(19) United States
(12) Patent Application Publication
(10) Pub. No.: US 2010/0244604 A1
(43) Pub. Date: Sep. 30, 2010

(54) POWER GENERATING APPARATUS AND MOTOR

(76) Inventor: Jin Dong Kim, Gumi-si (KR)

Correspondence Address: KED & ASSOCIATES, LLP, P.O. Box 221200, Chantilly, VA, 20153-1200, US

(21) Appl. No.: 12/740,472

(22) PCT Filed: Oct. 29, 2008
(86) PCT No.: PCT/KR08/06387

§ 371 Date: Apr. 29, 2010

(30) Foreign Application Priority Data
Oct. 30, 2007 (KR) 20-2007-0017574
Mar. 6, 2008 (KR) 20-2008-0003010

(51) Int. Cl. H02K 1/02; H02K 1/17

(52) U.S. Cl. 310/154.01; 310/216.001

(57) ABSTRACT

A power generating apparatus and a motor are disclosed. The disclosed power generating apparatus comprises a stator being comprised of nonferrous metal; and a rotator. The disclosed motor comprises a field iron core; a motor case being comprised of nonferrous metal; and a stator magnet having the same width as the width of a magnet facing portion of the field iron core. By he disclosed power generating apparatus and the disclosed motor, the efficiency is enhanced.

### TECHNICAL FIELD

The present invention relates to a power generating apparatus and a motor.

### BACKGROUND ART

A power generating apparatus changes dynamics energy, heat energy, chemical energy into electric energy.

The power generating apparatus is comprised of a stator and a rotator. Coils wind around the stator, and permanent magnets is installed in the rotator. the rotator rotates round the stator. If the rotator is rotated by the outside energy, so the electric energy is generated at the coils.

The motor generates changes the electric energy into driving power. The motor is used broadly across all industries.

The motor is comprised of a stator and a rotator. Coils wind around the stator, and permanent magnets is installed in the rotator.

In the conventional power generating apparatus, the stator is made of iron, so when the rotator rotates, magnetic attraction work between the stator and the permanent magnets. The magnetic attraction act as resistance, therefore the efficiency of the power generating apparatus is lower.

In the conventional motor, a magnetic field is generatid between the rotator and the case of the stator, therefore the efficiency of the motor is lower.

### DISCLOSURE OF INVENTION

### Technical Problem

An object of the present invention is to provide a power generating apparatus and a motor which enhances efficiency.

### Technical Solution

To achieve this object, according to an aspect of the present invention, a power generating apparatus comprises a stator on which coils being wound, and being comprised of nonferrous metal; and a rotator capable of rotating for the stator, and in which magnets are installed and interacts with the coils to generate electricity.

According to other aspect of the present invention, a power generating apparatus comprises a stator being comprised of nonferrous metal, and comprising a stator body and stator projections which are projected from the stator body and between which coils are wound; a rotator capable of rotating for the stator, and in which magnets are installed and interacts with the coils to generate electricit; and an iron fixture being comprised of iron, and being arranged between the stator projections.

According to another aspect of the present invention, a motor changes electric energy into driving power, and comprises a field iron core being comprised in a rotator, on which coils being wound; a motor case being comprised in a stator, being comprised of nonferrous metal; and a stator magnet generating a magnetic field with the field iron core, and having the same width as the width of a magnet facing portion of the field iron core.

an aspect of the stator magnet which faces the magnet facing portion of the field iron core is a plane surface.

the stator magnet has the same length as the lentgh of the magnet facing portion of the field iron core.

### ADVANTAGEOUS EFFECTS

Therefore, the present invention has following advantageous effects.

First, the stator of the power generating apparatus of the present invention is comprised of nonferrous metal, so when the power generating apparatus works, the interaction between the magnet of the rotator and the body of the stator is minimized Therefore, the rotating motion of the rotator go smoothly, and the efficiency of the power generating apparatus is enhanced.

Second, the stator of the power generating apparatus of the present invention is comprised of nonferrous metal, so when the power generating apparatus works, heat generated at the inside of the power generating apparatus is emitted to the outside of the power generating apparatus smoothly.

Third, the stator of the power generating apparatus of the present invention is comprised of nonferrous metal, the weight of the stator is decreased, so the production and the dealing for the stator are convenient.

Fourth, the iron fixture of the power generating apparatus of the present invention is arranged at the stator, so the coils are wound stably, and the magnetic force is concentrated at the coils. Therefore, the efficiency of the power generating apparatus is enhanced.

Fifth, the body of the rotator of the power generating apparatus of the present invention has a magnet inserting hole into which the magnet is inserted, so the combining process is simple.

Sixth, the stator of the power generating apparatus of the present invention is a layer-built thing of thin stator forming panels, so the production is convenient.

Seventh, the motor case of the motor of the present invention is comprised of nonferrous metal, so the interaction between the field iron core and the other portion of the motor case at which the magnet is not arranged is minimized. Therefore, the rotating motion of the rotator go smoothly, and the efficiency of the motor is enhanced.

Eighth, in the motor of the present invention, the magnetic force is concentrated at the portion between the magnet facing portion of the field iron core and the magnet, and the magnetic force is minimized at the other portion of the motor case. Therefore, the rotating motion of the rotator go smoothly, and the efficiency of the motor is enhanced.

Ninth, in the motor of the present invention, the stator magnet which faces the magnet facing portion of the field iron core is a plane surface, so the magnetic force is concentrated at the portion between the magnet facing portion of the field iron core and the magnet. Therefore, the rotating motion of the rotator go smoothly, and the efficiency of the motor is enhanced.

Tenth, in the motor of the present invention, a stator magnet cover covers the stator magnet and is combined with the motor case, so the stator magnet is not seceded from the motor case by an outside force. Therefore, a conveyance of the motor is convenient, and the motor works stably.

Eleventh, the stator magnet cover of the motor of the present invention is comprised of iron, so the stator magnet cover is magnetized by the stator magnet. Therefore, a magnetic field loss at the portion between the magnet facing portion of the field iron core and the magnet is minimized.

### BRIEF DESCRIPTION OF DRAWINGS

FIG. 1 is a combined perspective view illustrating a power generating apparatus according to the first embodiment of the present invention.

FIG. 2 is a perspective view illustrating a stator of the power generating apparatus according to the first embodiment of the present invention.

FIG. 3 is a perspective view illustrating a rotator of the power generating apparatus according to the first embodiment of the present invention.

FIG. 4 is a cross section view of the power generating apparatus according to the first embodiment of the present invention.

FIG. 5 is a partial enlargement view illustrating the stator on which coils is wound of the power generating apparatus according to the first embodiment of the present invention.

FIG. 6 is a view illustrating a stator forming panel being comprised in the stator of the power generating apparatus according to the first embodiment of the present invention.

FIG. 7 is a view illustrating a layer-built thing of the stator forming panel of FIG. 6.

FIG. 8 is a perspective view illustrating an iron fixture of the stator of the power generating apparatus according to the first embodiment of the present invention.

FIG. 9 is a perspective view illustrating the coils of the stator of the power generating apparatus according to the first embodiment of the present invention.

FIG. 10 is a perspective view illustrating the rotator in which the magnet is inserted of the power generating apparatus according to the first embodiment of the present invention.

FIG. 11 is a perspective view illustrating the magnet being inserted in the rotator of the power generating apparatus according to the first embodiment of the present invention.

FIG. 12 is a perspective view illustrating features which the magnet is inserted in the rotator of the power generating apparatus according to the first embodiment of the present invention.

FIG. 13 is a cross section view of the motor according to the second embodiment of the present invention.

FIG. 14 is a side view illustraing a stator magnet and a rotator of the motor according to the second embodiment of the present invention.

FIG. 15 is a perspective view illustraing pre-installation features of the stator magnet of the motor according to the third embodiment of the present invention.

FIG. 16 is a cross section view illustraing post-installation features of the stator magnet of FIG. 15.

### BEST MODE FOR CARRYING OUT THE INVENTION

Reference will now be made in detail to the preferred embodiments of the present invention, examples of which are illustrated in the accompanying drawings.

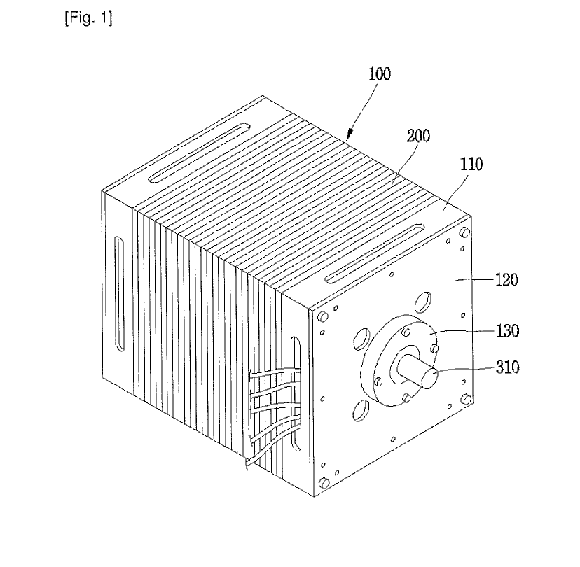

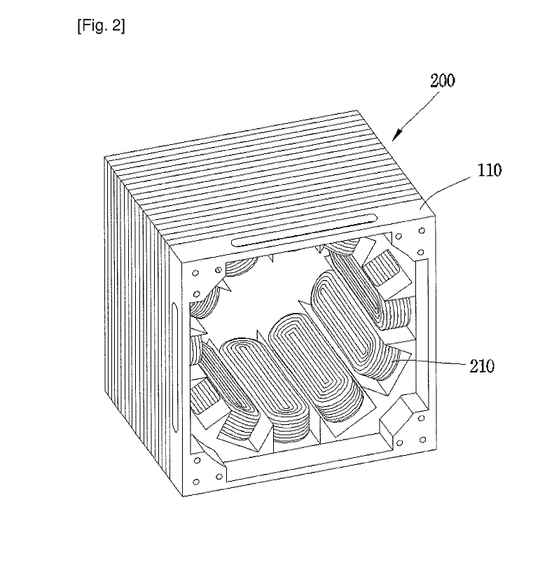

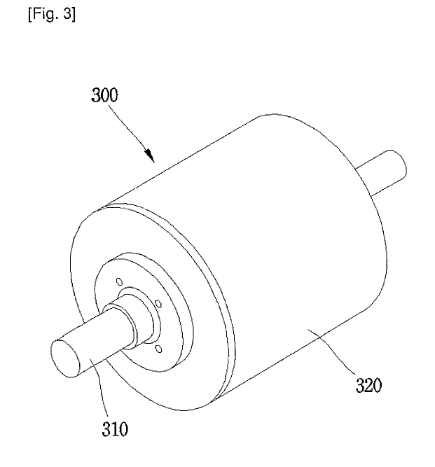

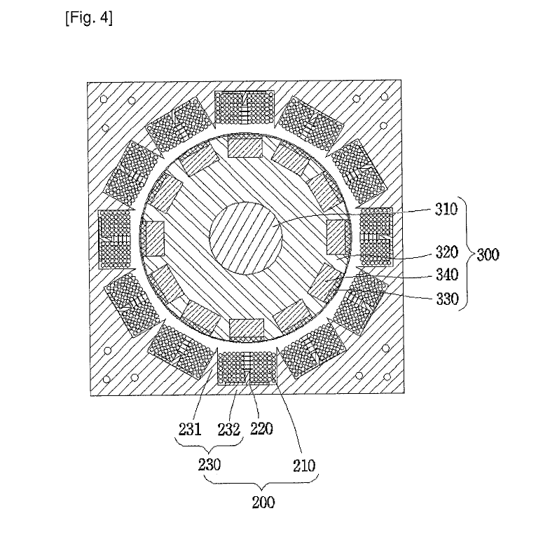

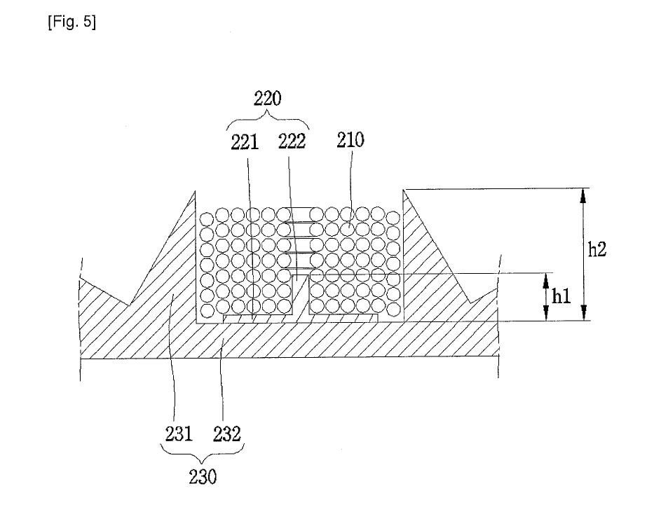

FIG. 1 is a combined perspective view illustrating a power generating apparatus according to the first embodiment of the present invention, FIG. 2 is a perspective view illustrating a stator of the power generating apparatus according to the first embodiment of the present invention, FIG. 3 is a perspective view illustrating a rotator of the power generating apparatus according to the first embodiment of the present invention, FIG. 4 is a cross section view of the power generating apparatus according to the first embodiment of the present invention, and FIG. 5 is a partial enlargement view illustrating the stator on which coils is wound of the power generating apparatus according to the first embodiment of the present invention.

As shown in FIG. 1 to 5, a power generating apparatus 100 of the present embodiment comprises a stator 200 and a rotator 300. combining panels 110 are formed at the front side and the rear side of the stator 200, and covers 120 are combined to the combining panels 110 separately.

the stator 200 is fixed to apparatuses (for example, an electric automobile, an electric motion scooter, a vessel, an air-conditioning apparatus for home etc.) to which the power generating apparatus 100 is combined, the rotator 300 interacts with the stator 200 and rotates, so the power generating apparatus 100 generates electricity.

Axis fixing portions 130 are formed at the center portion of the covers 120, an axis of rotation 310 is installed in the axis fixing portion 130 to be able to rotate, the rotation of the axis of rotation 310 goes smoothly by a method of installing bearings between the axis fixing portions 130 and the axis of rotation 310, etc.

the stator 200 comprises coils 210, an iron fixture 220 and a coil arranging portion 230.

the coils 210 are formed by a method of winding cupper wires and each end portions of the coils 210 is connected to an outside electricity apparatus. When the rotator 300 rotates, electricity is induced at the coils 210, so the electricity is supplied to the outside electricity apparatus through the each end portions of the coils 210.

stator projections 231 and coil arranging base 232 is formed at the coil arranging portion 230.

the stator projections 231 are projected from the body of the stator 200. the coils 210 are arranged at the space between the adjacent stator projections 231 stably.

For an efficient space use, the stator projections 231 become narrow in the direction of the inner side of the stator 200. For example, the section of the stator projections 231 is formed in a triangle shape.

The coil arranging base 232 is the portion of the body of the stator 200 being formed between the stator projections 231. the coils 210 are arranged at the coil arranging base 232 stably.

After the coils 210 are arranged at the coil arranging base 232 stably, the coils 210 to be sunk, the portions between the stator projections 231 are filled with insulators. So, the coils 210 are fixed stably and insulated. Of course, covers for covering the coils 210 are used.

The plural coils 210 arranged at the stator 200 are arranged by a method of an electrical series connection or a parallel connection according to a use etc. of the power generating apparatus 100. By the method of the connection, the number of output of power of the power generating apparatus 100 is adjusted to be coincided with the desired number.

In this embodiment, the stator 200 is comprised of nonferrous metal as stainless, aluminum. Because the interaction of nonferrous metal and a magnet is smaller than the interaction of iron and a magnet, when the power generating apparatus 100 works, the interaction between the magnet 340 of the rotator 300 and the body of the stator 200 is minimized Therefore, the rotating motion of the rotator 300 go smoothly, and the efficiency of the power generating apparatus 100 is enhanced. And, when the power generating apparatus 100 works, heat generated at the inside of the power generating apparatus 100 is emitted to the outside of the power generating apparatus 100 smoothly. And, the weight of the stator 200 is decreased, so the production and the dealing for the stator 200 are convenient.

The iron fixture 220 is comprised of iron and is combined at the coil arranging base 232. the iron fixture 220 comprises a base portion 211 connected to the coil arranging base 232 and a projection portion 222 projected from the center portion of the base portion 211.

As shown in FIG. 5, the height h1 of the iron fixture 220, namely the height of the projection portion 222 is lower than the height h2 of the stator projection 231. So, by the combination of the iron fixture 220, the coils 210 are wound stably. And, the magnetic force is concentrated at the coils 210, so the efficiency of the power generating apparatus 100 is enhanced.

The rotator 300 is connected to the stator 200 capable of rotating for the stator 200 by the axis of rotation 310. The rotator 300 comprises the axis of rotation 310, the rotator body 320, the magnet cover 330 and the magnet 340.

Grooves, namely magnet inserting holes at which the magnets 340 are combined are formed at the surface of the rotator body 320 according to the circumference of the rotator body 320. The magnet cover 330 is fixed at the groove, so the room for inserting the magnet 340 is formed. Therefore, the combining process of the magnet 340 is simple.

Here, besides the method, Holes at which the magnets 340 are combined are penetrated at the rotator body 320 according to the circumference of the rotator body 320.

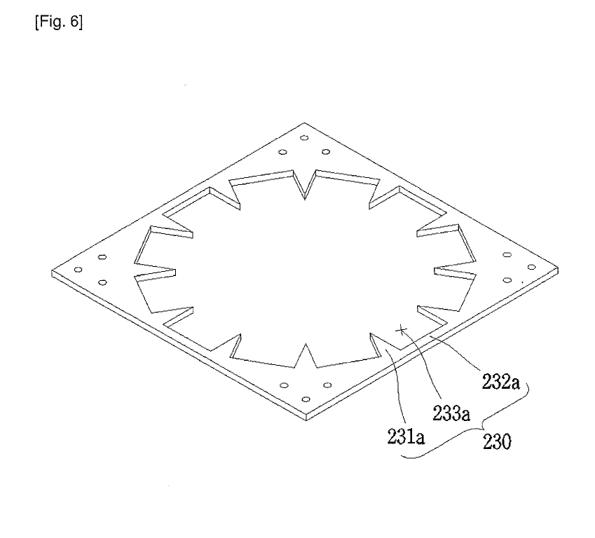

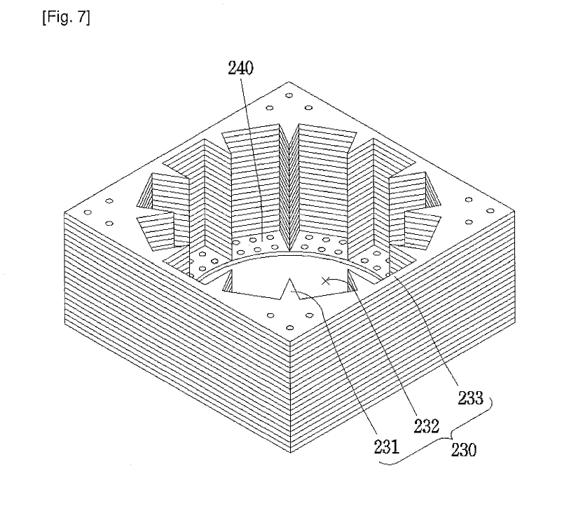

FIG. 6 is a view illustrating a stator forming panel being comprised in the stator of the power generating apparatus according to the first embodiment of the present invention, and FIG. 7 is a view illustrating a layer-built thing of the stator forming panel of FIG. 6.

As shown in FIGS. 6 and 7, the stator 200 of FIG. 6 is a layer-built thing of thin stator forming panels 230a of FIG. 7.

Because the stator forming panels 230a is thin, foaming and builting of the stator forming panels 230a is simple, so the production of the stator 200 is convenient.

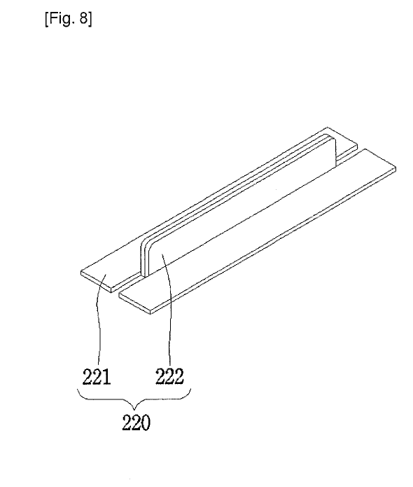

FIG. 8 is a perspective view illustrating an iron fixture of the stator of the power generating apparatus according to the first embodiment of the present invention.

As shown in FIG. 8, the iron fixture 220 of the stator 200 comprises the base portion 221 and the projection portion 222, and formed into the reversed “T” shape.

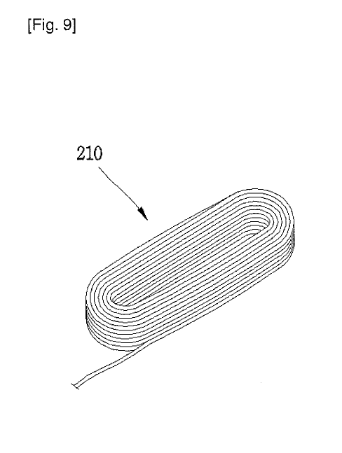

FIG. 9 is a perspective view illustrating the coils of the stator of the power generating apparatus according to the first embodiment of the present invention.

As shown in FIG. 9, the coils 210 of the stator 200 are electric wires and formed into the wound shape. If the coils 210 is taped, the production of the coils 210 is simple without the wound thing for winding the coils 210.

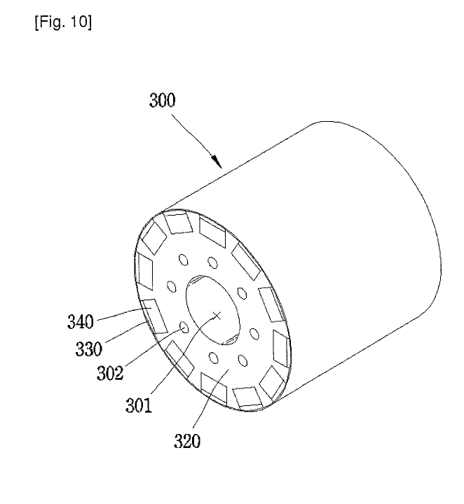

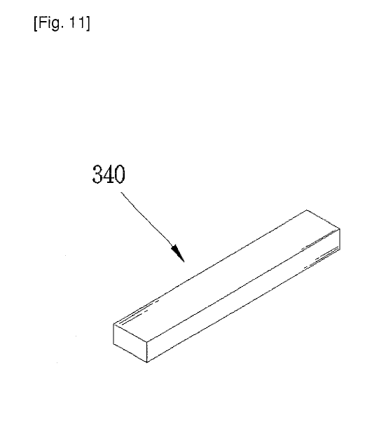

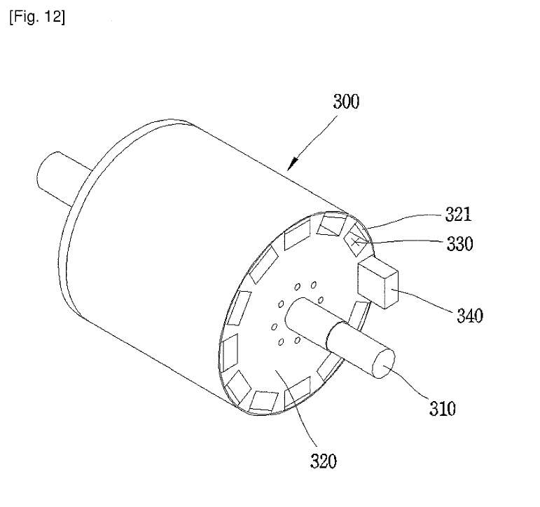

FIG. 10 is a perspective view illustrating the rotator in which the magnet is inserted of the power generating apparatus according to the first embodiment of the present invention, FIG. 11 is a perspective view illustrating the magnet being inserted in the rotator of the power generating apparatus according to the first embodiment of the present invention, and FIG. 12 is a perspective view illustrating features which the magnet is inserted in the rotator of the power generating apparatus according to the first embodiment of the present invention.

As shown in FIGS. 10 to 12, the magnet 340 of FIG. 11 is a rectangular parallelepiped shape and inserted into the magnet inserting hole 321 of the stator 300, so the production of the rotator 300 is simple.

Therefore, the power generating apparatus 100 of the present invention has following advantageous effects.

First, the stator 200 of the power generating apparatus 100 of the present invention is comprised of nonferrous metal, so when the power generating apparatus 100 works, the interaction between the magnet 340 of the rotator 300 and the body 320 of the stator 300 is minimized. Therefore, the rotating motion of the rotator 300 go smoothly, and the efficiency of the power generating apparatus 100 is enhanced.

Second, the stator 200 of the power generating apparatus 100 of the present invention is comprised of nonferrous metal, so when the power generating apparatus 100 works, heat generated at the inside of the power generating apparatus 100 is emitted to the outside of the power generating apparatus 100 smoothly.

Third, the stator 200 of the power generating apparatus 100 of the present invention is comprised of nonferrous metal, the weight of the stator 200 is decreased, so the production and the dealing for the stator 200 are convenient.

Fourth, the iron fixture 220 of the power generating apparatus 100 of the present invention is arranged at the stator 200, so the coils 210 are wound stably, and the magnetic force is concentrated at the coils 210. Therefore, the efficiency of the power generating apparatus 100 is enhanced.

Fifth, the body 320 of the rotator 300 of the power generating apparatus 100 of the present invention has the magnet inserting hole 321 into which the magnet 340 is inserted, so the combining process is simple.

Sixth, the stator 200 of the power generating apparatus 100 of the present invention is the layer-built thing of the thin stator forming panels 230a, so the production is convenient.

### MODE FOR THE INVENTION

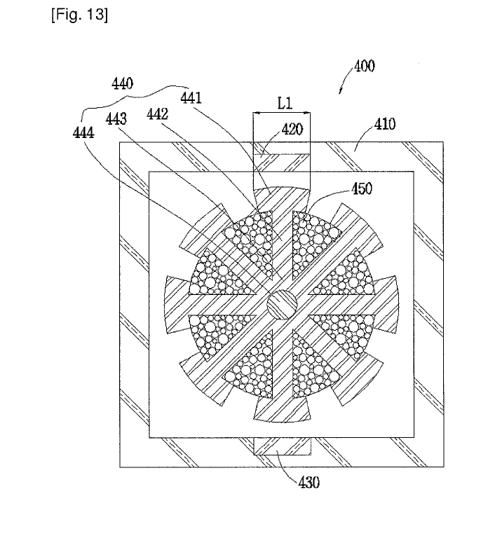

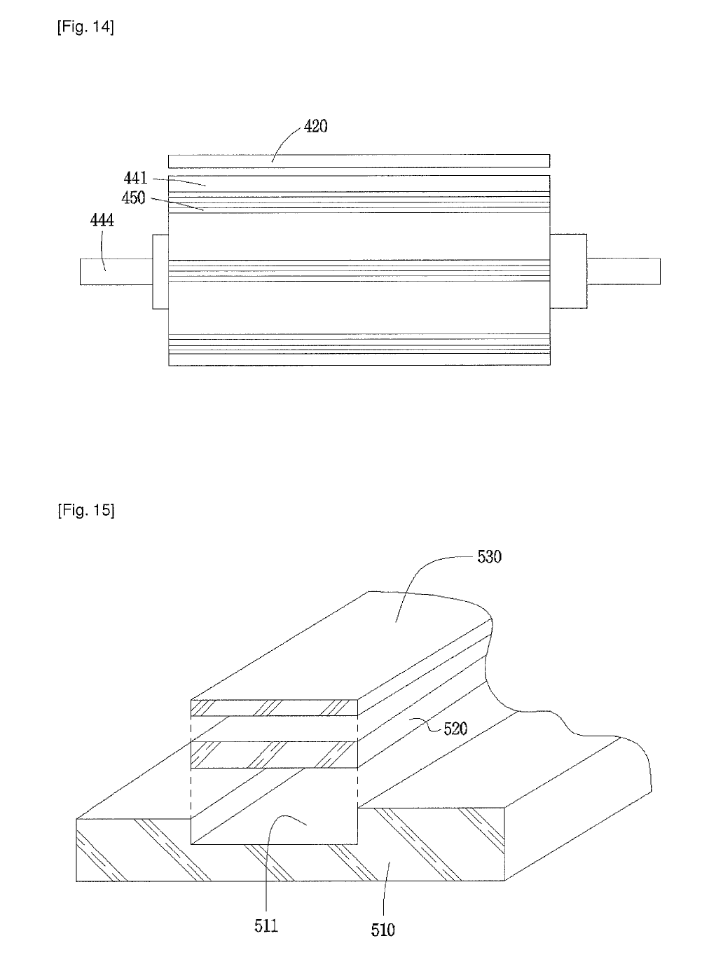

FIG. 13 is a cross section view of the motor according to the second embodiment of the present invention, and FIG. 14 is a side view illustraing a stator magnet and a rotator of the motor according to the second embodiment of the present invention.

As shown in FIGS. 13 and 14, a motor 400 of the present embodiment changes electricity into driving power by rotating a rotator for a stator, and comprises a field iron core 440, a motor case 410 and stator magnets 420, 430.

The field iron core 440 constitutes the rotator, and is wound by coils 450. The field iron core 440 comprises a magnet facing portion 441, a wound portion 442, an axis inserting portion 443 and an axis of rotation 444.

The magnet facing portion 441 faces the stator magnets 420, 430, and is formed with a set width. The magnet facing portion 441 is located at the end portion of the wound portion 442.

The coils 450 is wound at the wound portion 442. If the electricity is suppled with the coils 450 wound at the wound portion 442, the field iron core 440 is magnetized, so the field is generated between the field iron core 440 and the stator magnet 420, 430. By the magnetic force according to the field, the rotator rotates.

The axis of rotation 444 is inserted into the axis inserting portion 443. The axis of rotation 444 is the center of the rotation for the rotator. Both end portions of the axis of rotation 444 are combined with the motor case 410 etc. capable of rotating.

The motor case 410 constitutes the stator of the motor 400 with the stator magnet 420, 430.

In this embodiment, the motor case 410 is comprised of nonferrous metal.

If the motor case is comprised of iron, the motor case is magnetized. So, the field is generated between the magnetized field iron core and the stator magnet and between the magnetized field iron core and the other portion of the motor case at which the stator magnet is not arranged. Therefore, because the rotator does not rotate smoothly, the efficiency of the motor is lower.

In this embodiment, the motor case 410 is comprised of nonferrous metal, so the interaction between the field iron core 440 and the other portion of the motor case 410 at which the stator magnet 420, 430 is not arranged is minimized. Therefore, the rotating motion of the rotator go smoothly, and the efficiency of the motor 400 is enhanced.

The stator magnet 420, 430 are arranged at the motor case 410, and generate the field with the field iron core 440, and have the same width as the width of the magnet facing portion of the field iron core 440. The stator magnet 420, 430 have the different poles separately. For example, the upper stator magnet 420 has the N pole, and the lower stator magnet 430 has the S pole. So, the magnetic force is concentrated at the portion between the magnet facing portion 441 of the field iron core 440 and the stator magnet 420, 430, and the magnetic force is minimized at the other portion of the motor case 410. Therefore, the rotating motion of the rotator go smoothly, and the efficiency of the motor 400 is enhanced.

The portion of the stator magnet 420, 430 which faces the magnet facing portion 441 of the field iron core 440 is a plane surface, so the magnetic force is concentrated at the portion between the magnet facing portion 441 of the field iron core 440 and the stator magnet 420, 430. Therefore, the rotating motion of the rotator go smoothly, and the efficiency of the motor 400 is enhanced.

In the following, the third embodiment of the present invention is explained. On this explaining, if the contents of the third embodiment overlap the contents of the second embodiment, the contents of the second embodiment substitute the ovelapped contents of the third embodiment, and the overlapped contents of the third embodiment is omitted.

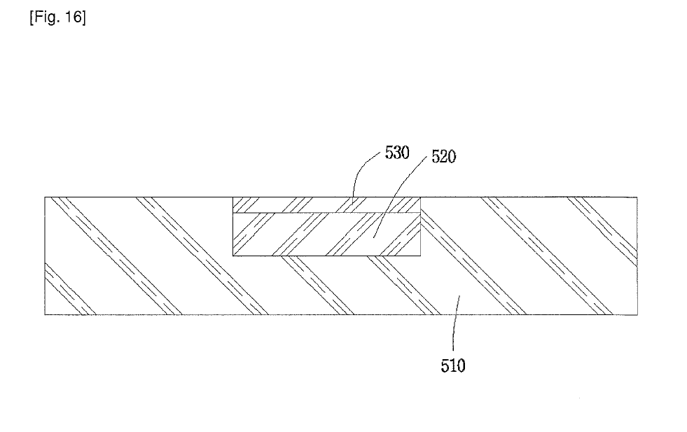

FIG. 15 is a perspective view illustraing pre-installation features of the stator magnet of the motor according to the third embodiment of the present invention, and FIG. 16 is a cross section view illustraing post-installation features of the stator magnet of FIG. 15.

As shown in FIGS. 15 and 16, the motor of the present embodiment further comprises a stator magnet cover 530 which covers the stator magnet 520 and combined with the motor case 510, the stator magnet 520 to be fixed.

In detail, as shown in FIG. 15, a stator magnet arranging hole 511 is formed at the motor case 510 by be sunk with the set depth. The stator magnet 520 is arranged at the stator magnet arranging hole 511.

After the stator magnet 520 is arranged at the stator magnet arranging hole 511, the upper portion of the stator magnet 520 is covered by the stator magnet cover 530. The stator magnet cover 530 can be combined by the method of bolting etc. at the motor case 510.

The stator magnet cover 530 covers the stator magnet 520 and is combined with the motor case 510, so the stator magnet 520 is not seceded from the motor case 510 by an outside force. Therefore, a conveyance of the motor is convenient, and the motor works stably.

And, if the stator magnet cover 530 is comprised of iron, the stator magnet cover 530 is magnetized by the stator magnet 520. Therefore, a magnetic field loss at the portion between the magnet facing portion 441 of the field iron core 440 and the stator magnet 520 is minimized.

It will be apparent to those skilled in the art that various modifications and variations can be made in the present invention without departing from the spirit or scope of the invention. Thus, it is intended that the present invention cover the modifications and variations of this invention provided they cone within the scope of the appended claims and their equivalents.

### INDUSTRIAL APPLICABILITY

Therefore, the present invention has a following industrial applicability.

The efficiency of the power generating apparatus and the motor is enhanced.

1. A power generating apparatus comprising:
a stator on which coils being wound, and being comprised of nonferrous metal; and
a rotator capable of rotating for the stator, and in which magnets are installed and interacts with the coils to generate electricity.

2. The power generating apparatus of claim 1, wherein the stator is comprised of at least one of stainless and aluminum.

3. The power generating apparatus of claim 1, wherein stator projections are projected from the stator, and the coils is arranged at the portion between the adjacent stator projections.

4. The power generating apparatus of claim 3, wherein the stator projections become narrow in the direction of the inner side of the stator.

5. The power generating apparatus of claim 3, wherein the portions between the adjacent stator projections are filled with insulators.

6. The power generating apparatus of claim 1, wherein the stator is a layer-built thing of thin stator forming panels.

7. The power generating apparatus of claim 1, wherein magnet inserting holes are formed at the surface portion of the rotator according to the circumference of the rotator.

8. The power generating apparatus of claim 7, wherein the magnet inserting holes is formed by grooves formed at the surface portion of the rotator and covers covered the grooves.

9. The power generating apparatus of claim 7, wherein the magnet inserting holes are penetrated at the surface portion of the rotator.

10. A power generating apparatus comprising:
a stator being comprised of nonferrous metal, and comprising a stator body and stator projections which are projected from the stator body and between which coils are wound;
a rotator capable of rotating for the stator, and in which magnets are installed and interacts with the coils to generate electricit; and
an iron fixture being comprised of iron, and being arranged between the stator projections.

11. The power generating apparatus of claim 10, wherein the iron fixture comprises a base portion connected to a base between the adjacent stator projections, and a projection portion projected from the base portion.

12. The power generating apparatus of claim 11, wherein the height of the projection portion is lower than the height of the stator projection.

13. A motor changing electric energy into driving power, wherein the motor comprises,
a field iron core being comprised in a rotator, on which coils being wound;
a motor case being comprised in a stator, being comprised of nonferrous metal; and
a stator magnet generating a magnetic field with the field iron core, and having the same width as the width of a magnet facing portion of the field iron core.

14. The motor of claim 13, wherein an aspect of the stator magnet which faces the magnet facing portion of the field iron core is a plane surface.

15. The motor of claim 13, wherein the length of the stator magnet is the same as the length of the magnet facing portion of the field iron core.

16. The motor of claim 13, wherein the motor further comprises a stator magnet cover which covers the stator magnet and combines with the motor case.

17. The motor of claim 16, wherein the stator magnet cover is comprised of iron.
